(19) United States
(12) Patent Application Publication
(10) Pub. No.: US 2011/0159708 A1
(43) Pub. Date: Jun. 30, 2011

(54) COAXIAL MICROSWITCH CONNECTOR

(75) Inventors: TUNG-LIANG HUANG, Hsin-Tien City (TW); Sung-Wen Chen, Hsin-Tien City (TW)

(73) Assignee: INSERT ENTERPRISE CO., LTD., Hsin-Tien City (TW)

(21) Appl. No.: 12/723,640

(22) Filed: Mar. 13, 2010

(30) Foreign Application Priority Data
Dec. 29, 2009 (TW) 098224642

(51) Int. Cl. H01R 12/00

(52) U.S. Cl. 439/63

(57) ABSTRACT

A coaxial microswitch connector includes a metal housing, an upper insulating cover, an elastic terminal, a fixed terminal and a lower insulating cover; the elastic terminal has a first fixed sheet and a first contact sheet, where two sides of the first contact sheet are respectively connected to an elastic sheet; the lowermost end of the elastic sheet has a bended section bended outward horizontally therefrom which can have contact with an upper end face of the lower insulating cover horizontally, thereby not piercing in the lower insulating cover; two buckling tabs of the upper insulating cover are respectively engaged with two buckling grooves of the lower insulating cover, ensuring that the upper insulating cover, the elastic terminal, the fixed terminal and the lower insulating cover are coupled to one another stably.

### BACKGROUND OF THE INVENTION

1. Field of the Invention

The present invention relates to a connector, and more particularly to a coaxial microswitch connector.

2. Description of Related Art There are many electric connectors with a switch disclosed by the patents such as Taiwan Patent Nos. 1260115, 1250701, 1232011, M327118 and U.S. Pat. Nos. 5,989,046, 6,390,840, 6,659,789, 6,761,571, 6,932,615, 7,080,997 and 7,458,834.

Taiwan Patent No. 582648 of the applicant of the present invention discloses a subminiature microswitch connector constituted by an external terminal, a upper insulating case, a movable terminal, a fixed terminal and a lower insulating case, where the upper end of the lower insulating case has an accepting groove matched up with the shape of the bottom of the upper insulating case and the two sides thereof are respectively disposed with an indented groove; a fixing piece of the movable terminal and a fixing piece of the fixed terminal are respectively coupled to the two indented grooves; two second deflectors of the external terminal are coupled to the lower end of the lower insulating case; the middle parts of the upper insulating case and the lower insulating case are formed to be a space for accepting a contact piece of the fixed terminal, a contact piece of the movable terminal and two spring pieces; the front end of the contact piece of the movable terminal is propped against the lower side of the contact piece of the fixed terminal.

The two sides of the movable terminal of the aforementioned patent are respectively coupled to a spring piece, thereby increasing the elasticity of the contact piece. But, the spring piece is curved, the lower end thereof pierces into the surface of the lower insulating case corresponding thereto easily and is fixed such that it cannot be restored to its original shape, causing the contact piece to lose a returning spring force such that a defective is formed. Furthermore, in the assembly process on a production line, when the movable terminal and the fixed terminal are placed between the upper insulating case and the lower insulating case and before they are moved to the next step for assembling the external terminal so as to fix the upper insulating case and the lower insulating case, the movable terminal and the fixed terminal are separated from the upper insulating case and the lower insulating case easily in the middle of moving because there is short of a buckling structure between the upper insulating case and the lower insulating case; an operator must reassemble them such that the time is consumed and they may be assembled at a wrong position to form a defective. Furthermore, a clip must be used manually to pick up assembled components to carry out the assembly because each of them is very tiny and it is unable to use a jig to carry out the assembly of many connectors simultaneously such that the assembly is labor and time consumption.

### SUMMARY OF THE INVENTION

To simplifying the structures of the movable terminal, fixed terminal and the upper insulating case of the aforementioned coaxial connector, allow manufacturing to be convenient, improve the elastic structure of a contact end of a movable terminal and decrease defective fraction, the present invention is proposed.

The main object of the present invention is to provide a coaxial microswitch connector, having a simpler structure, being easier to be assembled and manufactured and increasing the production efficiency.

Another object of the present invention is to provide a coaxial microswitch connector, having a reliable elastic structure and a long life.

### BRIEF DESCRIPTION OF THE DRAWINGS

The present invention can be more fully understood by reference to the following description and accompanying drawings, in which:

FIG. 1 is an exploded view of a connector of the present invention;

FIG. 2 is another exploded view of a connector of the present invention;

FIG. 3 is a perspective view of a connector of the present invention;

FIG. 4 is a schematic view, showing the assembly of a plurality of upper insulating covers, elastic terminals, fixed terminals and lower insulating covers;

FIG. 5 is a schematic view, showing a plurality of upper insulating covers, elastic terminals, fixed terminals and lower insulating covers coupled to a first material strip and a second material strip;

FIG. 6 is a schematic view, showing the integration of a upper insulating cover, elastic terminal, fixed terminal and lower insulating cover;

FIG. 7 is another schematic view, showing the integration of a upper insulating cover, elastic terminal, fixed terminal and lower insulating cover;

FIG. 8 is a cross sectional view, showing a connector of the present invention and another connector; and

FIG. 9 is a cross sectional view, a connector of the present invention in which another connector is inserted.

### DETAILED DESCRIPTION OF THE PREFERRED EMBODIMENTS

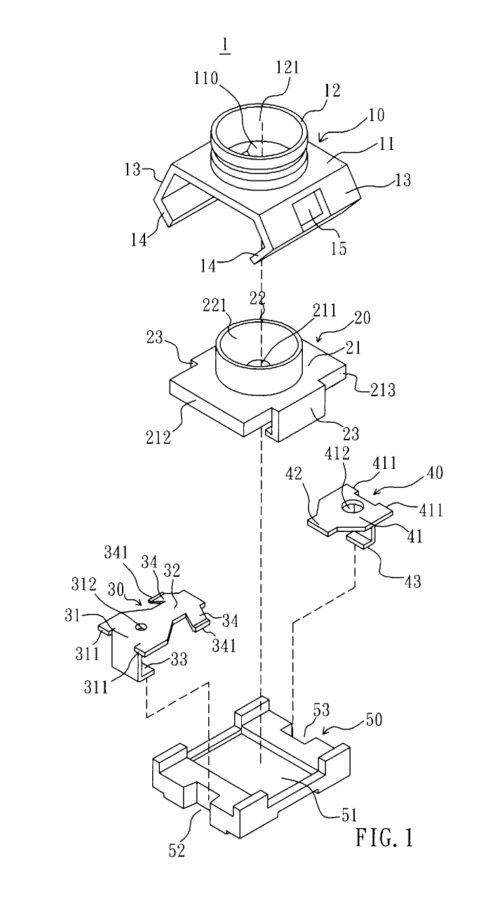

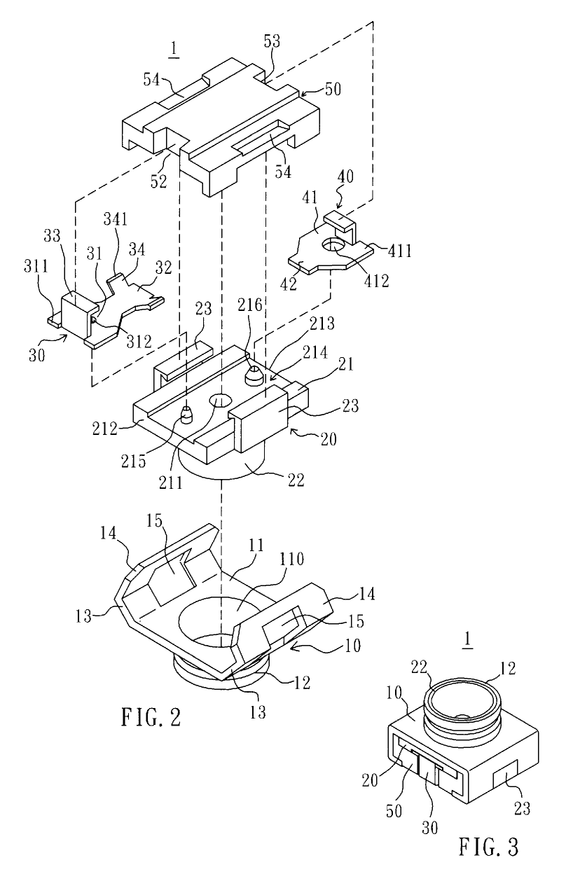

Referring to FIGS. 1, 2 and 3, a coaxial microswitch connector 1 of the present invention includes a metal housing 10, an upper insulating cover 20, an elastic terminal 30, a fixed terminal 40 and a lower insulating cover 50, where the metal housing 10, elastic terminal 30 and fixed terminal 40 are made from metal material, and the upper insulating cover 20 and lower insulating cover 50 are made from insulating material such as plastic or resin. The shape of the metal housing 10 shown in FIGS. 1 and 2 is one before being assembled.

The metal housing 10 has a first plate 11, where a first hole 110 is disposed on the middle of the first plate 11. A first cylinder 12 is extended upward from the first plate 11 outside the first hole 110. A first opening 121 of the first cylinder 12 is communicated with the first hole 110. A first bended sheet 13 is respectively bended downward from the opposite sides of the first plate 11. A second bended sheet 14 is bended inward from the lower end of each first bended sheet 13. The first bended sheet 13 and the second bended sheet 14 have a engagement hole 15.

The upper insulating cover 20 has a second plate 21, second cylinder 22 and two buckling tabs 23. A second hole 211 is disposed on the middle of the second plate 21. The second plate 21 is connected to a second cylinder 22 extended upward therefrom at the circumference of the second hole 211. The inside of the second cylinder 22 has a horn-shaped second opening 221 communicated with the second hole 211. the two opposite sides of the second plate 21 has a first section 212 and a second section 212 with one end thereof farer away from the second cylinder 22, and the other two opposite sides of the second plate 21 are respectively coupled to a buckling tab 23 extended downward therefrom. The bottom of the second plate 21 is disposed with a groove 214 and differently shaped first projecting pin 215 and second projecting pin 216, where the first projecting pin 215 and the second projecting pin 216 are respectively positioned on the groove 214 in the ranges of the first section 212 and the second section 213 and longer than the depth of the groove 214.

The elastic terminal 30 has a first fixed sheet 31 and a first contact sheet 32 connected to each other. The two sides of the first fixed sheet 31 respectively have a first connecting sheet 311. The lower end of the first fixed sheet 31 is connected to a second connecting sheet 33 adapted to join a circuit board with solder. The first fixed sheet 31 is disposed with a first through hole 312 corresponding to the first projecting pin 215. The two sides of the first contact sheet 32 are respectively connected to a elastic sheet 34 which is bended downward from the first contact sheet 32, where the lowermost end of the elastic sheet 34 has a bended section 341 bended outward horizontally therefrom.

The fixed terminal 40 has a second fixed sheet 41 and a second contact sheet 42, where the two sides of the second fixed sheet 41 respectively have a third connecting sheet 411. The second fixed sheet 41 is disposed with a second through hole 412 corresponding to the second projecting pin 216. The lower end of the second fixed sheet 41 is connected to a fourth connecting sheet 43 adapted to join a circuit board with solder.

The upper end face of the lower insulating cover 50 has an accepting groove 51, and one pair of the two sides of the lower insulating cover 50 are respectively disposed with a first indentation section 52 and a second indentation section 53 respectively matching the second connecting sheet 33 of the elastic terminal 30 and the fourth connecting sheet 43 of the fixed terminal 40. The lower end faces of the other two sides of the lower insulating cover 50 are disposed with a buckling groove 54 which can be engaged with the buckling tab 23 of the upper insulating cover 20.

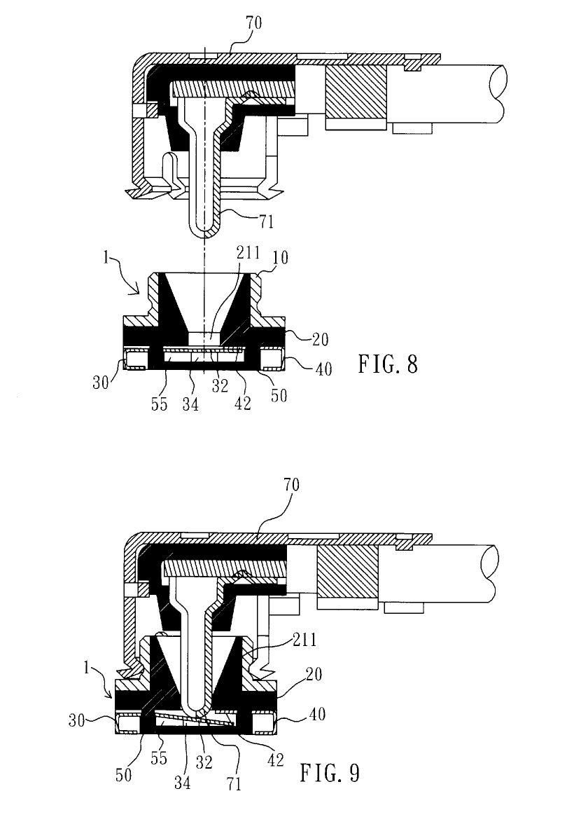

Referring to FIGS. 1, 2, 3 and 8, when the coaxial microswitch connector 1 of the present invention is assembled, the second through hole 412 of the fixed terminal 40 is first engaged with the second projecting pin 216 of the second section 213 of the upper insulating cover 20, ensuring that the second fixed sheet 41 and the second contact sheet 42 are positioned in the groove 214 of the second plate 21 and the second contact sheet 42 is not allowed to block the second hole 211 of the upper insulating cover 20. Next, the first through hole 312 of the elastic terminal 30 is engaged with the first projecting pin 215 of the first section 212 of the upper insulating cover 20, ensuring that the first fixed sheet 31 and the first contact sheet 32 are positioned in the groove 214 of the second plate 21 and the first contact sheet 32 is allowed to block the second hole 211 and stack under the second contact sheet 42. Furthermore, the upper insulating cover 20 is stacked on the upper end of the lower insulating cover 50, ensuring that the two buckling tabs 23 are respectively engaged with the two buckling grooves 54 and the second connecting sheet 33 and the fourth connecting sheet 43 are respectively accepted in the first indentation section 52 and the second indentation section 53 of the lower insulating cover 50. Furthermore, the second cylinder 22 of the upper insulating cover 20 is placed in the first cylinder 12 of the metal housing 10, and the upper insulating cover 20 and the lower insulating cover 50 are placed between the two first bended sheets 13 and between the two bended sheets 14. Finally, the two first bended sheets 13 and the two second bended sheets 14 of the metal housing 10 are bended to cause the two first bended sheets 13 to be respectively attached closely to the two sides of the upper insulating cover 20 and the two sides of the lower insulating cover 50; the two engagement holes 15 respectively accept the two buckling tabs 23, and the two second bended sheets 14 are caused to prop against the lower side of the lower insulating cover 50. The first fixed sheet 31 and the first contact sheet 32 are placed between the first section 212 of the second plate 21 and the lower insulating cover 50, the second fixed sheet 41 and the second contact sheet 42 are placed between the second section 213 of the second plate 21 and the lower insulating cover 50, and the metal housing 10, the upper insulating cover 20, the elastic terminal 30, the fixed terminal 40 and the lower insulating cover 50 are coupled together to form a structure shown in FIG. 1. As FIG. 8 shows, the upper insulating cover 20 and the accepting groove 51 of the lower insulating cover 50 form a space 55 for accepting the first contact sheet 32, the second contact sheet 42 and the two elastic sheets 34, where the first contact sheet 32 is propped against the lower side of the second contact sheet 42, and the lower end of each elastic sheet is propped against the upper end face of the lower insulating cover 50.

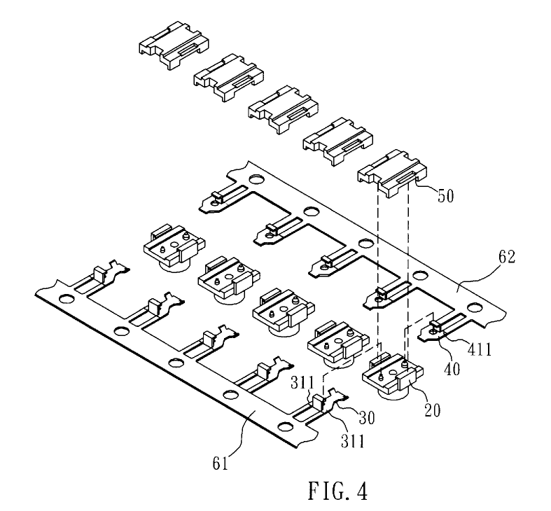

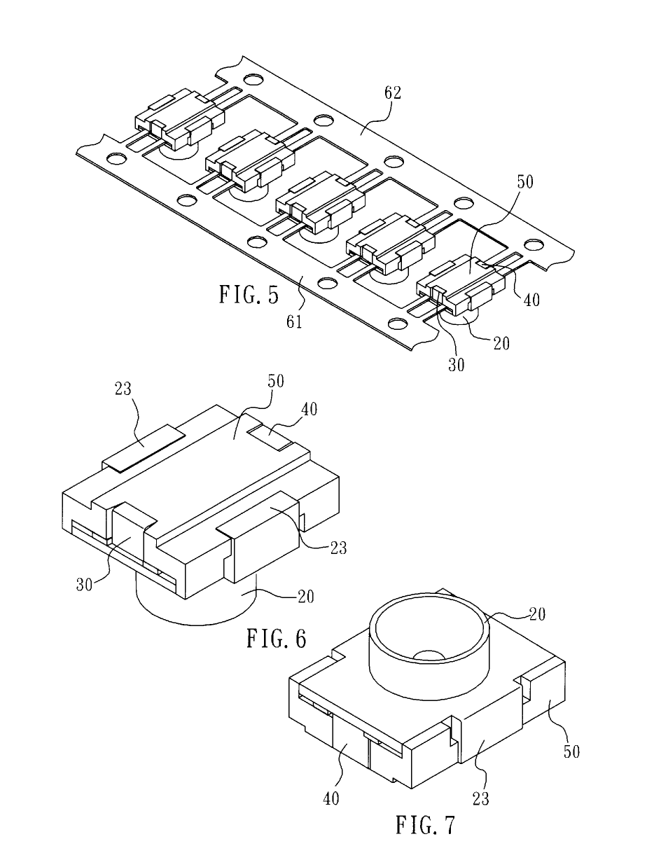

Referring to FIGS. 4, 5, 6 and 7, the first connecting sheets 311 of the plurality of elastic terminal 30 are connected to a first material strip 61, and the third connecting sheets 411 of the plurality of fixed terminals 40 are connected to a second material strip 62 such that an assembly jig being coupled to the first material strip 61 and the second material strip 62 can be used to carry out the operation of the plurality of elastic terminals 30 and the plurality of fixed terminals 40 being respectively assembled with the plurality of upper insulating covers 20 and the plurality of lower insulating covers 50, ensuring that the first material strip 61 and the second material strip 62 are respectively integrated with the plurality of upper insulating covers 20, the plurality of elastic terminals 30, the plurality of fixed terminals 40 and the plurality of lower insulating covers 50 as FIG. 5 shows. Next, the first connecting sheets 311 and the third connecting sheets 411 are cut off, and a plurality of assembled structures including the upper insulating cover 20, elastic terminal 30, fixed terminal 40 and the lower insulating cover 50 can then be obtained as FIGS. 6 and 7 show. The two buckling tabs 23 of the upper insulating cover 20 are respectively engaged with the two buckling grooves 54 of the lower insulating cover 50, ensuring that the upper insulating cover 20, the elastic terminal 30, the fixed terminal 40 and the lower insulating cover 50 can be combined together stably, and the separation thereof will not happen while being moved to the next step of the assembly with the metal housing 10. Besides, because the first through hole 312 and the second through hole 412 respectively correspond to the differently shaped first projecting pin 215 and second projecting pin 216 such that they can only respectively be engaged with the first projecting pin 215 and the second projecting pin 216. Therefore, a incorrect assembly will not happen.

Referring to FIG. 8 again, a terminal 71 of another connector 70 may be passed through the second hole 211 of the upper insulating cover 20 of the coaxial microswitch connector 1 of the present invention to prop against the first contact sheet 32 of the elastic terminal 30.

Referring to FIGS. 1 and 9, the terminal 71 drives the first contact 32 to bend downward and deform to separate from the second contact sheet 42 and meanwhile cause the bended sections 341 of the two elastic sheets 34 to prop against and deform the lower insulating cover 50 when the terminal 71 is moved downward. The first contact sheet 32 can be recovered to the state of the first contact sheet 32 propping against the lower side of the second contact sheet 42 through a spring force generated from the deformation thereof and a spring force generated from the deformation of the two elastic sheets 34 as FIG. 8 shows after the terminal 71 is drawn out.

According to the present invention, the two elastic sheets 34 are used to not only strengthen the spring force of the first contact sheet 32 to stabilize the contact with the terminal 71 such that the quality of signal transmission can be increased but allow the first contact sheet 32 rather not to generate elastic fatigue to lose spring force such that the life of the connector can be extended. The bended section 341 bended outward horizontally from the lowermost end of the elastic sheet 34 of the present invention can have contact with the upper end face of the lower insulating cover 50 horizontally, and not pierce in the upper end face of the lower insulating cover 50 such that it is not retained there, thereby solving the problem of being unable to recover back to the original shape that happens in the prior art. Furthermore, in the assembly process on a production line, because the first connecting sheets 311 of the plurality of elastic terminals 30 are connected to the first material strip 61, and the third connecting sheets 411 of the plurality of fixed terminals 40 are connected to the second material strip 62, an assembly jig may be used to couple to the first material strip 61 and the second material strip 62 so as to carry out the operations of the plurality of elastic terminals 30 and the plurality of fixed terminal 40 being respectively assembled with the plurality of upper insulating covers 20 and the plurality of lower insulating covers 50. Besides, because the two buckling tabs 23 of the upper insulating cover 20 are respectively engaged with the two buckling grooves 54 of the lower insulating cover 50, the upper insulating cover 20, the elastic terminal 30, the fixed terminal 40 and the lower insulating cover 50 can be coupled together stably, and they are not separated from one another even when they are moved to the next operation step of being assembled with the metal housing 10. Therefore, the manufacturing and the assembly are easier, labor and time can be consumed, the defectives can be decreased, and the production cost can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A coaxial microswitch connector, comprising:
a metal housing, having a first plate; a first hole being disposed on a middle of said first plat; a first cylinder being extended outward from said first plate at an outside of said first hole; a first opening of said first cylinder being communicated with said first hole; two sides of said first plate being respectively bended downward to form a first bended sheet; said first bended sheets being respectively bended inward to forma second bended sheet;
a upper insulating cover, having a second plate; a second hole being disposed on a middle of said second plate; a second cylinder being extended upward from said second plate at an outside of said second hole; an inside of said second cylinder having a second opening communicated with said second hole; one pair of opposite sides of said second plate having a first section and a second section;
an elastic terminal, having a first fixed sheet and a first contact sheet connected to each other; two sides of said first contact sheet being respectively connected to an elastic sheet; said elastic sheet being bended downward from said first contact sheet; a lowermost end of said elastic sheet having a bended section bended outward horizontally therefrom;
a fixed terminal, having a first fixed sheet and a second contact sheet connected to each other;
a lower insulating cover, a upper end face thereof having an accepting groove;
wherein, said second cylinder is positioned inside said first cylinder of said metal housing; said first fixed sheet and said first contact sheet are positioned between said first section of said second plate and said lower insulating cover, and said first contact sheet blocks said second hole; said second fixed sheet and said second contact sheet are positioned between said second section of said second plate and said lower insulating cover, said second contact sheet does not block said second hole of said upper insulating cover; said first contact sheet is stacked under said second contact sheet; said upper insulating cover is stacked on said lower insulating cover; said first bended sheet is attached to sides of said upper insulating cover and said lower insulating cover closely, said second bended sheet is propped against a lower side of said lower insulating cover; said upper insulating cover and said accepting groove of said lower insulating cover form a space for accepting said first contact sheet, said second contact sheet and said elastic sheet.

2. The coaxial microswitch connector according to claim 1, wherein another pair of opposite sides of said second plate are respectively coupled to a buckling tab extended downward therefrom; said lower insulating cover is disposed with a buckling groove corresponding to said buckling tab; said buckling tab is engaged with said buckling groove.

3. The coaxial microswitch connector according to claim 1, wherein said first fixed sheet has a first connecting sheet used for connecting to a first material strip and a second connecting sheet used for joining a circuit board with solder; said second fixed sheet has a third connecting sheet used for connecting to a second material strip and a fourth connecting sheet used for joining a circuit board with solder.

4. The coaxial microswitch connector according to claim 2, wherein said first fixed sheet has a first connecting sheet used for connecting to a first material strip and a second connecting sheet used for joining a circuit board with solder; said second fixed sheet has a third connecting sheet used for connecting to a second material strip and a fourth connecting sheet used for joining a circuit board with solder.

5. The coaxial microswitch connector according to claim 1, wherein a bottom of said second plate is disposed with a first projecting pin and a second projecting pin; said first fixed sheet is disposed with a first through hole corresponding to said first projecting pin; said first through hole is engaged with said first projecting pin; said second fixed sheet is disposed with a second through hole corresponding to said second projecting pin; said second through hole is engaged with said second projecting pin.

6. The coaxial microswitch connector according to claim 5, wherein said first projecting pin and said second projecting pin are different in shape.

7. The coaxial microswitch connector according to claim 6, wherein a bottom of said second plate is disposed with a groove; said first projecting pin and said second projecting pin are respectively positioned in the scope of said groove.

8. The coaxial microswitch connector according to claim 2, wherein a bottom of said second plate is disposed with a first projecting pin and a second projecting pin; said first fixed sheet is disposed with a first through hole corresponding to said first projecting pin; said first through hole is engaged with said first projecting pin; said second fixed sheet is disposed with a second through hole corresponding to said second projecting pin; said second through hole is engaged with said second projecting pin.

9. The coaxial microswitch connector according to claim 8, wherein said first projecting pin and said second projecting pin are different in shape.

10. The coaxial microswitch connector according to claim 9, wherein a bottom of said second plate is disposed with a groove; said first projecting pin and said second projecting pin are respectively positioned in the scope of said groove.

11. The coaxial microswitch connector according to claim 3, wherein a bottom of said second plate is disposed with a first projecting pin and a second projecting pin; said first fixed sheet is disposed with a first through hole corresponding to said first projecting pin; said first through hole is engaged with said first projecting pin; said second fixed sheet is disposed with a second through hole corresponding to said second projecting pin; said second through hole is engaged with said second projecting pin.

12. The coaxial microswitch connector according to claim 11, wherein said first projecting pin and said second projecting pin are different in shape.

13. The coaxial microswitch connector according to claim 12, wherein a bottom of said second plate is disposed with a groove; said first projecting pin and said second projecting pin are respectively positioned in the scope of said groove.

14. The coaxial microswitch connector according to claim 13, wherein said lower insulating cover is disposed with a first indentation section and a second indentation section respectively matching said second connecting sheet and said fourth connecting sheet.

15. The coaxial microswitch connector according to claim 4, wherein a bottom of said second plate is disposed with a first projecting pin and a second projecting pin;
said first fixed sheet is disposed with a first through hole corresponding to said first projecting pin; said first through hole is engaged with said first projecting pin; said second fixed sheet is disposed with a second through hole corresponding to said second projecting pin; said second through hole is engaged with said second projecting pin.

16. The coaxial microswitch connector according to claim 15, wherein said first projecting pin and said second projecting pin are different in shape.

17. The coaxial microswitch connector according to claim 16, wherein a bottom of said second plate is disposed with a groove; said first projecting pin and said second projecting pin are respectively positioned in the scope of said groove.

18. The coaxial microswitch connector according to claim 17, wherein said lower insulating cover is disposed with a first indentation section and a second indentation section respectively matching said second connecting sheet and said fourth connecting sheet.
